(19) United States
(12) Patent Application Publication
(10) Pub. No.: US 2015/0185598 A1
(43) Pub. Date: Jul. 2, 2015

(54) LASER PROJECTION APPARATUS

(71) Applicants: Qisda Optronics (Suzhou) Co., Ltd., Suzhou (CN); Qisda Corporation, Taoyuan (TW)

(72) Inventor: KAI-JING WANG, Tainan City (TW)

(21) Appl. No.: 14/583,131

(22) Filed: Dec. 25, 2014

(30) Foreign Application Priority Data
Dec. 26, 2013 (TW) 102148477

(51) Int. Cl. G03B 21/20

(52) U.S. Cl. CPC G03B 21/2033; G03B 21/2066; G03B 21/2073

(57) ABSTRACT

A laser projection apparatus includes a light mixing module and a light splitting module. The light mixing module includes a first laser set, a quarter-wave plate, a first dichroic mirror and a reflector. The first laser set includes first and second laser sources for emitting first and second light with the same polarization, respectively. The first dichroic mirror reflects the first light along a first path and reflects the second light to pass through the quarter-wave plate. The reflector reflects the second light back to the quarter-wave plate, then the second light passes through the quarter-wave plate and the first dichroic mirror and then is mixed with the first light along the first path thereby forming a laser beam. The light splitting module receives the laser beam and splits the laser beam into a plurality of color lights.

### FIELD OF THE INVENTION

The present invention relates to a laser projection apparatus, and more particularly to a laser projection apparatus with a narrowing laser beam by a specific configuration of dichroic mirror, quarter-wave plate and reflector.

### BACKGROUND OF THE INVENTION

Basically, general laser projection apparatus uses a light mixing module and a light splitting module to corporately form a plurality of color lights for image projection. Please refer to FIG. 1, which is a schematic structural view of a conventional laser projection apparatus. As shown in FIG. 1, the conventional laser projection apparatus 10 includes a light mixing module 12, a light guiding module 14 and a light splitting module 16. The light mixing module 12 includes a plurality of reflectors 18, a plurality of first laser light sources 20 and a plurality of second laser light sources 22. The light guiding module 14 includes a convex lens 24, a reflector 26 and a concave lens 28.

As shown in FIG. 1, the reflectors 18 are spaced with regular intervals and tilted relative to the first and second laser light sources 20 and 22. The first laser light sources 20 are disposed to aim at the reflectors 18, respectively. The second laser light sources 22 and the reflectors 18 are staggered relative to the convex lens 24. The light emitted from the first laser light sources 20 can be reflected by the reflectors 18; and the light emitted from the second laser light sources 22 can pass through the intervals between the reflectors 18. Then, the light emitted from the first laser light sources 20 and reflected by the reflectors 18 and the light emitted from the second laser light sources 22 and passing through the intervals are mixed with each other thereby forming a laser beam. The laser beam is then emitted to the convex lens 24. Thus, after sequentially passing through the convex lens 24, being reflected by the reflector 26 and passing through the concave lens 28, the laser beam formed by the first and second laser light sources 20 and 22 is reduced by the light guiding module 14 and is able to be received by the light splitting module 16.

Then, the light splitting module 16 splits the laser beam into a plurality of color lights (such as red, blue and green lights) for the following image projection. To get a better understanding of the conventional laser projection apparatus 10 of FIG. 1, the following description is based on that both of the first and second laser light sources 20 and 22 are blue laser light sources and accordingly the laser beam produced by the light mixing module 12 and the light guiding module 14 is a blue laser beam. As shown in FIG. 1, the light splitting module 16 includes a dichroic mirror 30, a phosphor color wheel 32 and a plurality of reflectors 34. When the blue laser beam emits to the dichroic mirror 30, the dichroic mirror 30 allows the blue laser beam to pass therethrough and then the blue laser beam emits to the phosphor color wheel 32. Thus, the phosphor powder on the phosphor color wheel 32 is activated by the blue laser beam and generates lights with colors different from the blue light (such as red and green lights, which are referred to as “non-blue” lights herein below). Then, the generated non-blue lights are reflected back to the dichroic mirror 30. Moreover, a portion of the blue laser beam capable of passing through the phosphor color wheel 32 is reflected by the reflectors 34 sequentially and then is emitted to the dichroic mirror 30 again. As a result, after the blue laser beam has passed through the dichroic mirror 30 twice and the above-mentioned non-blue light has been reflected by the dichroic mirror 30, the light splitting module 16 splits the blue laser beam into a plurality of color lights for the following image projection.

However, according to the aforementioned description, it is to be noted that the reflectors 18 are required to be spaced with regular intervals, the first laser light sources 20 aims at the reflectors 18, respectively, and the second laser light sources 22 and the reflectors 18 are disposed to have an interlacing arrangement. Thus, the light mixing module 12 may not have a compact size and consequentially the conventional laser projection apparatus 10 may not have a miniaturization design due to the presence or existence of the intervals between the adjacent two reflectors 18, the adjacent two first laser light sources 20 and the adjacent two second laser light sources 22.

### SUMMARY OF THE INVENTION

Therefore, one object of the present invention is to provide a laser projection apparatus capable of directly generating a reduced-size laser beam by using a specific configuration of dichroic mirror, quarter-wave plate and reflector.

The present invention provides a laser projection apparatus which includes a light mixing module and a light splitting module. The light mixing module includes a first laser set, a quarter-wave plate, a first dichroic mirror and a reflector. The first laser set includes a first laser source and a second laser source. The first laser source is for emitting a first light. The second laser source is disposed opposite to the first laser source and for emitting a second light, wherein the first light and the second light have the same polarization. The quarter-wave plate is disposed near the first laser set. The first dichroic mirror is disposed between the first laser source and the second laser source and oblique relative to the quarter-wave plate. The first dichroic mirror reflects the first light along a first path and reflects the second light to pass through the quarter-wave plate. The reflector is parallel to the quarter-wave plate and for reflecting the second light passing through the quarter-wave plate back to the quarter-wave plate, wherein the second light is sequentially reflected by the reflector, passes through quarter-wave plate and the first dichroic mirror, and is mixed with the first light along the first path thereby forming a laser beam. The light splitting module is for receiving the laser beam and splitting the laser beam into a plurality of color lights.

In summary, to narrow a laser beam, the laser projection apparatus of the present invention adopts dichroic mirror, quarter-wave plate and reflectors instead of the conventional configuration. Because the light guiding module in prior art is omitted, the laser projection apparatus of the present invention has compact size and miniaturization design.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic structural view of a conventional laser projection apparatus; and

FIG. 2 is a schematic structural view of a laser projection apparatus in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

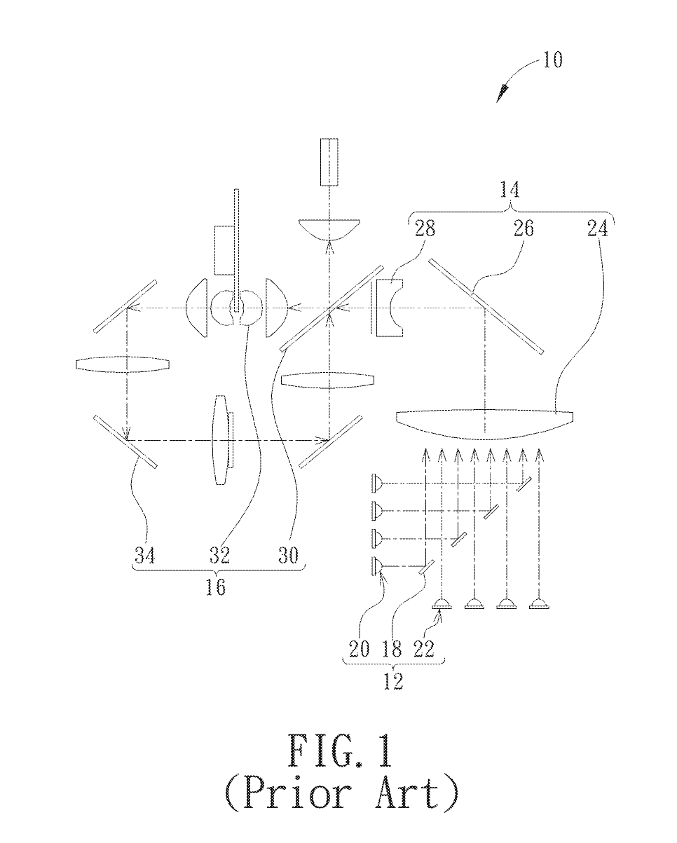

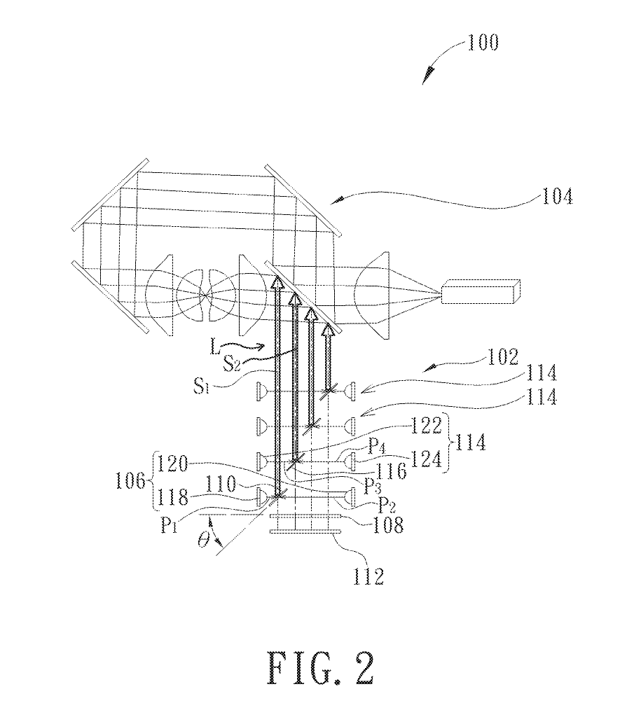

Please refer to FIG. 2 which is a schematic structural view of a laser projection apparatus 100 in accordance with an embodiment of the present invention. As shown in FIG. 2, the laser projection apparatus 100 in the present embodiment includes a light mixing module 102 and a light splitting module 104. The light splitting module 104 is adjacent to the light mixing module 102, and is used for receiving the laser beam L produced by the light mixing module 102 and splitting the laser beam L into a plurality of color lights (such as red, blue and green lights) which the laser projection apparatus 100 requires for the following image projection. Similar to the conventional light splitting module 16 of FIG. 1, the light splitting module 104 also includes a dichroic mirror, a phosphor color wheel and a plurality of reflectors. Because the component configuration of the light splitting module has been described previously, no any redundant detail to be given herein. The light mixing module 102 includes a first laser set 106, a quarter-wave plate 108, a first dichroic mirror 110, a reflector 112, at least one second laser set 114 (FIG. 2 is exemplified by the light mixing module 102 as illustrated having three second laser sets 114, however the present invention is not limited thereto) and at least one second dichroic mirror 116. The other components in the laser projection apparatus 100 (such as the imaging module and the projecting module) are well known to those ordinarily skilled in the art, thus, no any redundant detail is to be given herein.

The first laser set 106 includes a first laser source 118 and a second laser source 120. The first laser source 118 is configured for emitting a first light P_{1.} The second laser source 120 is disposed opposite to the first laser source 118 and is configured for emitting a second light P₂. In one embodiment, preferably, both of the first and second laser sources 118 and 120 are Blue-ray laser diodes; however, it is understood that the first and second laser sources 118 and 120 may have other types of implementations according to the practical application of the laser projection apparatus 100 and the present invention is not limited thereto. The first light P₁ and the second light P₂ may be any general polarization light (such as P-polarization light, S-polarization light) with the same polarization.

The quarter-wave plate 108 is disposed near the first laser set 106 and for changing the polarization of the light passing therethrough to have one-quarter phase difference. For instance, an S-polarization light is changed to a circular polarization light once the S-polarization light passes through the quarter-wave plate 108. The first dichroic mirror 110 is disposed between the first and second laser sources 118 and 120. Specifically, the first dichroic mirror 110 is aligned with the first and second laser sources 118 and 120 and oblique relative to the quarter-wave plate 108. The first dichroic mirror 110 is an optical component capable of reflecting the first and second lights P₁ and P₂ and allowing a light, having a polarization different from that of the first and second lights P₁ and P₂ to pass therethrough. Thus, through the first dichroic mirror 110, the first light P₁ is reflected along a first path S₁ and the second light P₂ is reflected to pass through the quarter-wave plate 108. Moreover, in this embodiment, the first dichroic mirror 110 is tilted 45 degrees relative to the quarter-wave plate 108 preferably; however, the present invention is not limited thereto. The reflector 112 is disposed parallel to the quarter-wave plate 108 and for reflecting the second light P₂ which passes through the quarter-wave plate 108 back to the quarter-wave plate 108. The second light P₂ which sequentially passes through the quarter-wave plate 108 and the first dichroic mirror 110 is mixed with the first light P₁ which is reflected by the first dichroic mirror 110 along the first path S₁ so as to form a laser beam L.

As shown in FIG. 2, the second laser sets 114 are disposed by the first laser set 106. Each of the second laser set 114 includes a third laser source 122 and a fourth laser source 124. The third laser source 122 is configured for emitting a third light P_{3.} The fourth laser source 124 is disposed opposite to the third laser source 122 and configured for emitting a fourth light P₄. In one embodiment, preferably, both of the third and fourth laser sources 122 and 124 are Blue-ray laser diodes; however, it is understood that the third and fourth laser sources 122 and 124 may have other types of implementations according to the practical application of the laser projection apparatus 100 and the present invention is not limited thereto. The third light P₃ and the fourth light P₄ may be any general light (such as P-polarization light, S-polarization light) having a polarization same as that of the aforementioned first light P₁ and the second light P₂. The second dichroic mirror 116 is disposed between the third and fourth laser sources 122 and 124. Specifically, the second dichroic mirror 116 is aligned with the third and fourth laser sources 122 and 124 and oblique relative to the quarter-wave plate 108. In one embodiment, the first dichroic mirror 110 and the second dichroic mirror 116 have the same tilt angle θ relative to the quarter-wave plate 108. The second dichroic mirror 116 is an optical component capable of reflecting the third and fourth lights P₃ and P₄ and allowing a light, having a polarization different from that of the third and fourth lights P₃ and P₄, to pass therethrough. Thus, through the second dichroic mirror 116, the third light P₃ is reflected along a second path S₂ and the fourth light P₄ is reflected to pass through the quarter-wave plate 108. The reflector 112 is further used for reflecting the fourth light P₄ passing through the quarter-wave plate 108 back to the quarter-wave plate 108. Thus, the fourth light P₄ sequentially passes through the quarter-wave plate 108 and the second dichroic mirror 116, which is mixed with the third light P₃ reflected by the second dichroic mirror 116 along the second path S₂.

According to the aforementioned description, it is to be noted that the first and second dichroic mirrors 110 and 116 are staggered relative to the quarter-wave plate 108. Specifically, in one preferred embodiment, the projections on the quarter-wave plate 108 of the first and second dichroic mirrors 110 and 116 are virtually connected with each other, as illustrated in FIG. 2. Thus, no interval or gap exists between the projections formed by the first and second dichroic mirrors 110 and 116 on the quarter-wave plate 108, and consequentially the laser beam L provided by the light mixing module 102 can be narrowed efficiently.

The process of the laser projection apparatus 100 producing the laser beam L will be described as follow. In the following exemplary process, a configuration of all of the first light P₁, the second light P₂, the third light P₃ and the fourth light P₄ being S-polarization lights and both of the first dichroic mirror 110 and the second dichroic mirror 116 being for reflecting S-polarization light and allowing P-polarization light to pass therethrough is taken as an example; however, the present invention is not limited thereto. In other words, all of the first light P₁, the second light P₂, the third light P₃ and the fourth light P₄ may be P-polarization lights and both of the first dichroic mirror 110 and the second dichroic mirror 116 can be for reflecting P-polarization light and allowing S-polarization light to pass therethrough in another embodiment.

As shown in FIG. 2, when the first and second lights P₁ and P₂ are emitted to the first dichroic mirror 110 and the third and fourth lights P₃ and P₄ are emitted to the second dichroic mirror 116, the first light P₁ and the third light P₃ are reflected by the first dichroic mirror 110 and the second dichroic mirror 116 along the first path S₁ and the second path S₂, respectively; and the second light P₂ and the fourth light P₄ are reflected by the first dichroic mirror 110 and the second dichroic mirror 116, respectively, to pierce the quarter-wave plate 108. Then, the second light P₂ and the fourth light P₄ passing through the quarter-wave plate 108 are changed from the S-polarization lights to the circular polarization lights which have one-quarter phase difference relative to the S-polarization lights, and are reflected by the reflector 112 to pierce the quarter-wave plate 108 again. Thus, the second light P₂ and the fourth light P₄ are changed from circular polarization lights to the P-polarization lights and pass through the first dichroic mirror 110 and the second dichroic mirror 116, respectively.

Then, the second light P₂, that has passed through the first dichroic mirror 110, and the first light P₁, that has been reflected by the first dichroic mirror 110, are mixed along the first path S₁ and the fourth light P₄, that has passed through the second dichroic mirror 116, and the third light P₃, that has been reflected by the second dichroic mirror 116, are mixed along the second path S_{2.} The first light P₁, the second light P₂, the third light P₃ and the fourth light P₄ corporately forms the laser beam L (e.g., a Blue laser beam).

According to the aforementioned description, it is to be noted that the first and second dichroic mirrors 110 and 116 are staggered and the projections thereof on the quarter-wave plate 108 are virtually connected with each other, as illustrated in FIG. 2. Thus, no interval or gap exists between the projections formed by the first and second dichroic mirrors 110 and 116 on the quarter-wave plate 108 and consequentially the laser beam L provided by the light mixing module 102 can be narrowed to a specific size which the light splitting module 104 may receive completely. Accordingly, the laser beam L can be directly provided to the light splitting module 104 without additional optics and is split into a plurality of color lights (such as red, blue and green lights) for the laser projection apparatus 100 to perform the following image projection. Because the splitting mechanism of the light splitting module 104 has been described previously and is well known to those ordinarily skilled in the art, no any redundant detail is to be given herein.

It should be noted that the aforementioned second laser set 114 and the second dichroic mirror 116 are optional. In other words, the laser projection apparatus 100 may use the first laser set 106, the first dichroic mirror 110, the quarter-wave plate 108 and the reflector 112 only to produce the laser beam L. Thus, the light mixing module 102 has a less complicated component configuration and consequentially the laser projection apparatus 100 has compact size.

In summary, to narrow a laser beam, the laser projection apparatus of the present invention adopts dichroic mirror, quarter-wave plate and reflectors instead of the conventional configuration. Because the light guiding module in prior art is omitted, the laser projection apparatus of the present invention has compact size and miniaturization design.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laser projection apparatus, comprising:
a light mixing module, comprising:
a first laser set, comprising:
a first laser source, the first laser source emitting a first light; and
a second laser source disposed opposite to the first laser source, the second laser source emitting a second light, wherein the first light and the second light have the same polarization;
a quarter-wave plate disposed near the first laser set;
a first dichroic mirror disposed between the first laser source and the second laser source and oblique relative to the quarter-wave plate, wherein the first dichroic mirror reflects the first light along a first path and reflects the second light to pass through the quarter-wave plate; and
a reflector disposed parallel to the quarter-wave plate and reflecting the second light passing through the quarter-wave plate back to the quarter-wave plate, wherein the second light is sequentially reflected by the reflector, passes through the quarter-wave plate and the first dichroic mirror, and is mixed with the first light along the first path thereby forming a laser beam; and
a light splitting module for receiving the laser beam and splitting the laser beam into a plurality of color lights.

2. The laser projection apparatus according to claim 1, wherein each one of the first and second laser sources is a Blue-ray laser diode.

3. The laser projection apparatus according to claim 1, wherein both of the first and second lights are P-polarization lights or S-polarization lights.

4. The laser projection apparatus according to claim 1, wherein the first dichroic mirror is tilted 45 degrees relative to the quarter-wave plate.

5. The laser projection apparatus according to claim 1, wherein the light mixing module further comprises:
at least a second laser set disposed by the first laser set, the second laser set comprising:
a third laser source, the third laser source emitting a third light; and
a fourth laser source disposed opposite to the third laser source, the fourth laser source emitting a fourth light, wherein the third light and the fourth light have a polarization same as that of the first light; and
a second dichroic mirror disposed between the third laser source and fourth laser source, the second dichroic mirror and the first dichroic mirror being staggered relative to the quarter-wave plate and oblique relative to the quarter-wave plate;
wherein the second dichroic mirror reflects the third light along a second path and reflects the fourth light to pass through the quarter-wave plate;
wherein the forth light is sequentially reflected by the reflector, passes through the quarter-wave plate and the second dichroic mirror, and is mixed with the third light along the second path thereby forming the laser beam with the first and second lights.

6. The laser projection apparatus according to claim 5, wherein each one of the first, second, third and fourth laser sources is a Blue-ray laser diode.

7. The laser projection apparatus according to claim 5, wherein all of the first, second, third and fourth lights are P-polarization lights or S-polarization lights.

8. The laser projection apparatus according to claim 7, wherein the first dichroic mirror and the second dichroic mirror are tilted 45 degrees relative to the quarter-wave plate.
